(19) United States
(12) Patent Application Publication
(10) Pub. No.: US 2018/0086598 A1
(43) Pub. Date: Mar. 29, 2018

(54) GROUP COORDINATION OF ELEVATORS WITHIN A BUILDING FOR OCCUPANT EVACUATION

(71) Applicant: Otis Elevator Company, Farmington, CT (US)

(72) Inventors: Ronnie E. Thebeau, Haddam, CT (US); James M. Collins, Burlington, CT (US); Jannah A. Stanley, Portland, CT (US); Paul A. Stranieri, Bristol, CT (US); David M. Hughes, East Hampton, CT (US)

(21) Appl. No.: 15/280,121

(22) Filed: Sep. 29, 2016

(51) Int. Cl. B66B 5/02; B66B 3/00; B66B 1/24

(52) U.S. Cl. CPC B66B 5/021; B66B 1/2458; B66B 3/002

(57) ABSTRACT

A method of operating a building elevator system including: controlling a first elevator system and a second elevator system, floor coverage of the first elevator system overlapping floor coverage of the second elevator system at a least one transfer floor; receiving an evacuation call from an evacuation floor; detecting when a first elevator car of the first elevator system is dispatched to the transfer floor; and dispatching a second elevator car of the second elevator system to the transfer floor.

### BACKGROUND

The subject matter disclosed herein relates generally to the field of elevator systems, and specifically to a method and apparatus for coordinating the operation of multiple elevator cars.

Commonly, very tall buildings (ex: high rise or sky scrapers) require sky lobbies or transfer floors, which are intermediate interchange (i.e. transfer) floors where people may transfer from an elevator serving an upper portion of the building to an elevator serving a lower portion of the building. Sky lobbies pose challenges during an evacuation and a more efficient solution is desired.

### BRIEF SUMMARY

According to one embodiment, a method of operating a building elevator system is provided. The method of operation a building elevator system includes: controlling a first elevator system and a second elevator system, floor coverage of the first elevator system overlapping floor coverage of the second elevator system at a least one transfer floor; receiving an evacuation call from an evacuation floor; detecting when a first elevator car of the first elevator system is dispatched to the transfer floor; and dispatching a second elevator car of the second elevator system to the transfer floor.

In addition to one or more of the features described above, or as an alternative, further embodiments of the method may include dispatching the second elevator car to a discharge floor after occupants have loaded into the second elevator car on the transfer floor.

In addition to one or more of the features described above, or as an alternative, further embodiments of the method may include dispatching the second elevator car to a second transfer floor after occupants have loaded into the second elevator car on the transfer floor.

In addition to one or more of the features described above, or as an alternative, further embodiments of the method may include determining a projected arrival time of the first elevator car at the transfer floor; wherein second elevator car is dispatched to arrive at the transfer floor within a selected time period of the projected arrival time.

In addition to one or more of the features described above, or as an alternative, further embodiments of the method may include providing, using a notification device, transfer instructions to occupants.

In addition to one or more of the features described above, or as an alternative, further embodiments of the method may include detecting, using a sensor system, a number of occupants within the first elevator car.

In addition to one or more of the features described above, or as an alternative, further embodiments of the method may include determining a number of elevators cars from the second elevator system to be dispatched to the transfer floor in response to the number of occupants within the first elevator car.

According to another embodiment, a control system of a building elevator system is provided. The control system including: a processor; a memory comprising computer-executable instructions that, when executed by the processor, cause the processor to perform operations. The operations include: controlling a first elevator system and a second elevator system, floor coverage of the first elevator system overlapping floor coverage of the second elevator system at a least one transfer floor; receiving an evacuation call from an evacuation floor; detecting when a first elevator car of the first elevator system is dispatched to the transfer floor; and dispatching a second elevator car of the second elevator system to the transfer floor.

In addition to one or more of the features described above, or as an alternative, further embodiments of the control system may include that the operations further include: dispatching the second elevator car to a discharge floor after occupants have loaded into the second elevator car on the transfer floor.

In addition to one or more of the features described above, or as an alternative, further embodiments of the control system may include that the operations further include: dispatching the second elevator car to a second transfer floor after occupants have loaded into the second elevator car on the transfer floor.

In addition to one or more of the features described above, or as an alternative, further embodiments of the control system may include that the operations further include: determining a projected arrival time of the first elevator car at the transfer floor; wherein the second elevator car is dispatched to arrive at the transfer floor within a selected time period of the projected arrival time.

In addition to one or more of the features described above, or as an alternative, further embodiments of the control system may include that the operations further include: providing, using a notification device, transfer instructions to occupants.

In addition to one or more of the features described above, or as an alternative, further embodiments of the control system may include that the operations further include: detecting, using a sensor system, a number of occupants within the first elevator car.

In addition to one or more of the features described above, or as an alternative, further embodiments of the control system may include that the operations further include: determining a number of elevators cars from the second elevator system to be dispatched to the transfer floor in response to the number of occupants within the first elevator car.

According to another embodiment, a computer program product tangibly embodied on a computer readable medium is provided. The computer program product including instructions that, when executed by a processor, cause the processor to perform operations. The operations includes: controlling a first elevator system and a second elevator system, floor coverage of the first elevator system overlapping floor coverage of the second elevator system at a least one transfer floor; receiving an evacuation call from an evacuation floor; detecting when a first elevator car of the first elevator system is dispatched to the transfer floor; and dispatching a second elevator car of the second elevator system to the transfer floor.

In addition to one or more of the features described above, or as an alternative, further embodiments of the computer program may include that the operations further include: dispatching the second elevator car to a discharge floor after occupants have loaded into the second elevator car on the transfer floor.

In addition to one or more of the features described above, or as an alternative, further embodiments of the computer program may include that the operations further include: dispatching the second elevator car to a second transfer floor after occupants have loaded into the second elevator car on the transfer floor.

In addition to one or more of the features described above, or as an alternative, further embodiments of the computer program may include that the operations further include: determining a projected arrival time of the first elevator car at the transfer floor, wherein the second elevator car is dispatched to arrive at the transfer floor within a selected time period of the projected arrival time.

In addition to one or more of the features described above, or as an alternative, further embodiments of the computer program may include that the operations further include: providing, using a notification device, transfer instructions to occupants.

In addition to one or more of the features described above, or as an alternative, further embodiments of the computer program may include that the operations further include: detecting, using a sensor system, a number of occupants within the first elevator car; and determining a number of elevators cars from the second elevator system to be dispatched to the transfer floor in response to the number of occupants within the first elevator car.

Technical effects of embodiments of the present disclosure include a control system to control the operation of a first elevator system and a second elevator system that share a transfer floor and command an elevator car of the second elevator system to move to the transfer floor to pick up passengers when an elevator car of the first elevator system is dispatched to the transfer floor. Technical effects also include coordinating the transfer of passengers at transfer floor from one elevator car to another elevator car.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an elevator assembly, in accordance with an embodiment of the disclosure;

FIG. 2 illustrates a schematic view of a building elevator system, in accordance with an embodiment of the disclosure; and

FIG. 3 is a flow chart of method of operating a building elevator system, in accordance with an embodiment of the disclosure.

### DETAILED DESCRIPTION

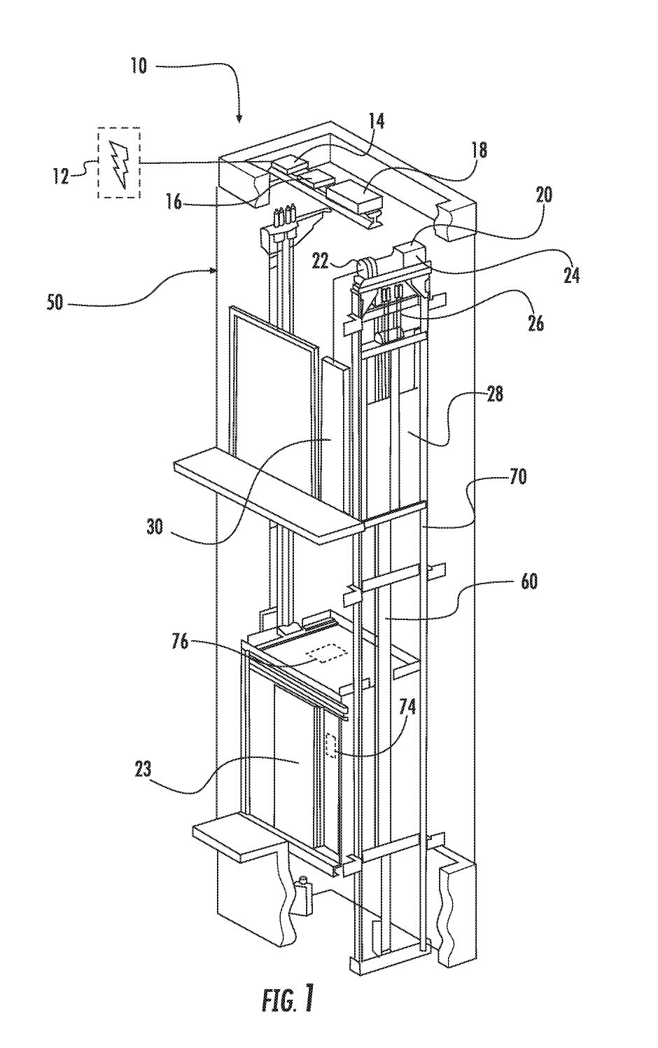

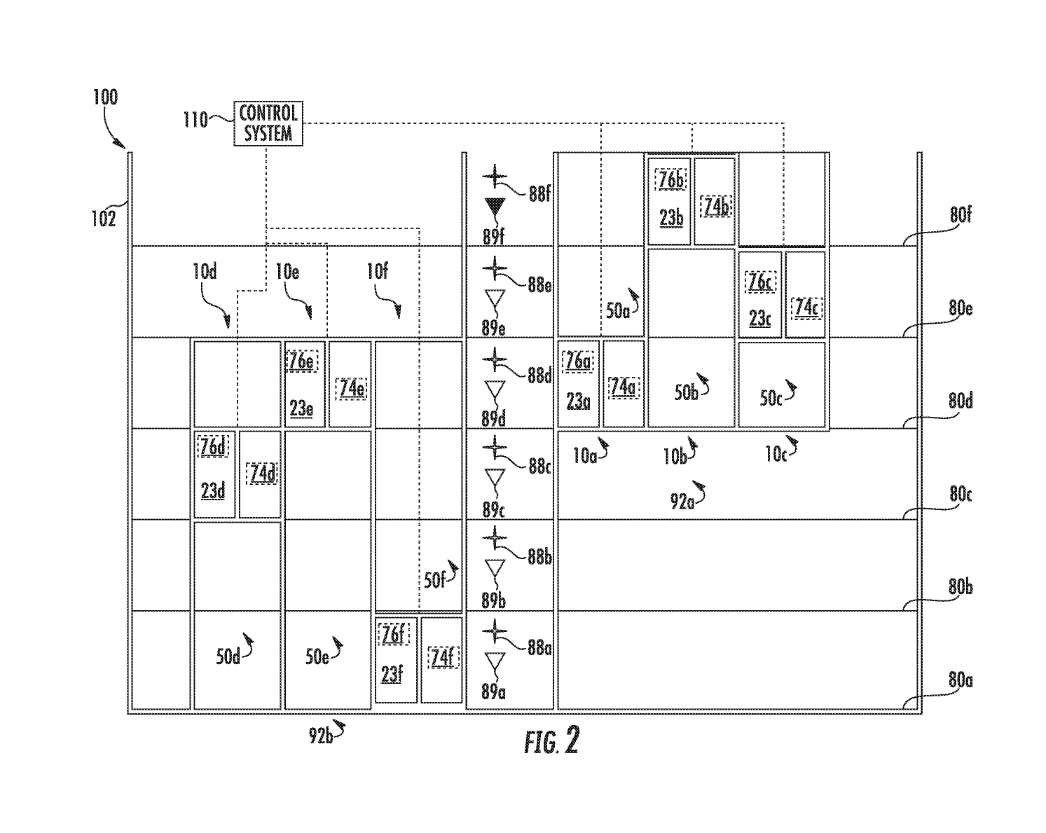

FIG. 1 shows a schematic view of an elevator assembly 10, in accordance with an embodiment of the disclosure. FIG. 2 shows schematic view of a building elevator system 100, in accordance with an embodiment of the disclosure. With reference to FIG. 1, the elevator assembly 10 includes an elevator car 23 configured to move vertically upward and downward within a hoistway 50 along a plurality of car guide rails 60. The elevator assembly 10 also includes a counterweight 28 operably connected to the elevator car 23 via a pulley system 26. The counterweight 28 is configured to move vertically upward and downward within the hoistway 50. The counterweight 28 moves in a direction generally opposite the movement of the elevator car 23, as is known in conventional elevator assemblies. Movement of the counterweight 28 is guided by counterweight guide rails 70 mounted within the hoistway 50.

The elevator assembly 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts AC power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator assembly 10 when an external power source is unavailable. The drive unit 20 drives a machine 22 to impart motion to the elevator car 23 via a traction sheave of the machine 22. The machine 22 also includes a brake 24 that can be activated to stop the machine 22 and elevator car 23. As will be appreciated by those of skill in the art, FIG. 1 depicts a machine room-less elevator assembly 10, however the embodiments disclosed herein may be incorporated with other elevator assemblies that are not machine room-less or that include any other known elevator configuration. In addition, elevator systems having more than one independently operating elevator car in each elevator shaft and/or ropeless elevator systems may also be used. In one embodiment, the elevator car may have two or more compartments.

The controller 30 is responsible for controlling the operation of the elevator assembly 10. The controller 30 is tied to a control system 110 (FIG. 2), which is responsible for controlling multiple elevator assemblies and will be discussed below. The controller 30 may also determine a mode (motoring, regenerative, near balance) of the elevator car 23. The controller 30 may use the car direction and the weight distribution between the elevator car 23 and the counterweight 28 to determine the mode of the elevator car 23. The controller 30 may adjust the velocity of the elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

As seen in FIG. 2, a building elevator system 100 within a building 102 may include multiple different individual elevators assemblies 10a-10f. The elevator assemblies 10 may be divided up into two or more elevator systems 92a, 92b. In very tall buildings (ex: high rise and skyscrapers) with a large number of floors 80a-80f, multiple elevator systems 92a, 92b may be used to get occupants to their destination faster and more efficiently. Multiple elevator systems 92a, 92b may also exist in shorter building for various other reasons including but not limited to, efficiency. FIG. 2 includes a first elevator system 92a and a second elevator system 92b. Floor coverage of each elevator system 92a, 92b typically overlap at a transfer floor (ex: sky lobby), so that occupants may disembark one elevator system and enter another. Buildings may have multiple transfer floors including a first transfer floor and a second transfer floor. As seen in FIG. 2, the floor coverage of the first elevator system 92a overlaps the floor coverage of the second elevator system 92b at floor 80d, which is considered the transfer floor. Each elevator system 92a, 92b may have one or more elevator assemblies 10a-10f having elevator cars 23a-23f in an elevator hoistway 50a-50d. In an embodiment, the first elevator system 92a is at a higher elevation than the second elevator system 92b. That is, the first elevator system 92a serves floors 80d-80f and the second elevator system 92b serves floors 80a-80d. In order for a passenger from floors 80a-80c to reach floors 80e-80f, they would need to transfer from second elevator system 92b to first elevator system 92a at floor 80d. While the building of FIG. 2 is depicted with six floors, a building may have any desired number of floors. Moreover, the second elevator system 92b and first elevator system 92a may each serve any number of independent and overlapping floors as desired.

Each floor 80a-80f in the building 102 of FIG. 2 may have an elevator call button 89a-89f and an evacuation alarm 88a-88f. The elevator call button 89a-89f sends an elevator call to the control system 110. The elevator call button 89a-89f may be a push button and/or a touch screen and may be activated manually or automatically. For example, the elevator call button 89a-89f may be activated by a building occupant pushing the elevator call button 89a-89f. The elevator call button 89a-89f may also be activated voice recognition or a passenger detection mechanism in the hallway, such as, for example a weight sensing device, a visual recognition device, and a laser detection device. The evacuation alarm 88a-88f may be activated or deactivated either manually or automatically through a fire alarm system. If the evacuation alarm 88a-88f is activated, an evacuation call is sent to the controller system 110 indicating the respective floor 80a-80f where the evacuation alarm 88a-88f was activated. In the example of FIG. 2, an evacuation alarm 88f is activated and floor 88d is the evacuation floor.

In a building having a second elevator system 92b and a first elevator system 92a, in the case of an evacuation, elevator cars 23a-23c of the first elevator system 92a may be carrying occupants to the transfer floor for evacuation and the control system 110 may send elevator cars 23d-23f of the second elevator system 92b to the transfer floor to receive the occupants exiting the elevator cars 23a-23c of the first elevator system 92a and, thereby, return them to the ground floor (or any other desired evacuation floor) for evacuation. In the example of FIG. 2, the ground floor may be floor 80a.

The control system 110 is operably connected to the controller 30 of each elevator assembly 10. The control system 110 is configured to the control and coordinate operation of multiple elevator systems 92a, 92b. The control system 110 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator systems 92a, 92b may also include a notification device 74 as seen in FIG. 1, and each elevator system 92a, 92b may include a notification device 74a-74f as seen in FIG. 2. The notification device 74a-74f may be located within the individual elevator cars 23a-23f or on the transfer floor. The notification device 74a-74f is in operative communication with the control system 110. The notification device 74a-74f is configured to provide transfer instructions to occupants. For example, the transfer instructions may describe where on the transfer floor to board an elevator car 23d-23f of the second elevator system 92b when the occupants are disembarking an elevator car 23a-23c of the first elevator system 92a. The notification device 74a-74f may provide transfer instructions in audible and/or visual form.

The elevator assemblies 10a-10f may also include a sensor system 76 configured to detect a number of occupants in a particular elevator car 23, as seen in FIG. 1. The sensor system 76 is also seen in FIG. 2, as sensor systems 76a-76f. The sensor system 76 is in operative communication with the control system 110. The sensor system 76 may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify and count individual passengers. The weight detection device may be a scale to sense the amount of weight in an elevator car 23 and then determine the number of passengers from the weight sensed. The laser detection device may detect how many passengers walk through a laser beam to determine the number of passengers in the elevator car 23. Similarly, a door reversal monitoring device also detects passengers entering the car so as not to close the elevator door on a passenger and thus may be used to determine the number of passengers in the elevator car 23. The thermal detection device may be an infrared or other heat sensing camera that utilizes detected temperature to identify and count individual passengers. The depth detection device may be a 2-D, 3-D or other depth/distance detecting camera that utilizes detected distance to an object to identify and count individual passengers. As may be appreciated by one of skill in the art, in addition to the stated methods, additional methods may exist to sense the number of passengers and one or any combination of these methods may be used to determine the number of passengers in the elevator car.

Advantageously, determining the number of occupants in an elevator car 23a-23c of the first elevator system 92a approaching the transfer floor may help the control system 110 determine how many elevators cars 23d-23f to send to the transfer floor from the second elevator system 92b. The control system 110 is configured to determine the number of occupants in an elevator car 23a-23c of the first elevator system 92a so as to send the appropriate number of elevators cars 23d-23f from the second elevator system 92b to the transfer floor, which will help expedite getting from passengers between the two elevator systems 92a, 92b.

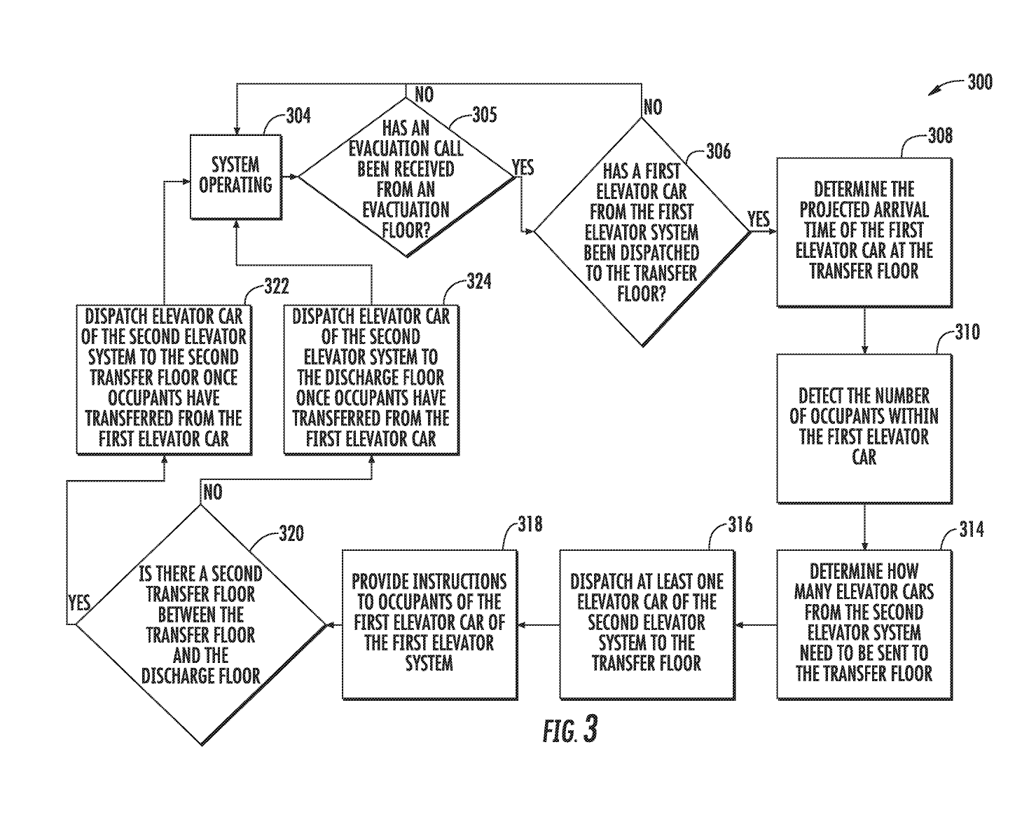

Referring now to FIG. 3, while referencing components of FIGS. 1 and 2. FIG. 3 shows a flow chart of method 300 of operating a building elevator system 100a-100f, in accordance with an embodiment of the disclosure. At block 304, the building elevator system 100a-100f is under normal operation. Under normal operation, the control system 110 is controlling the first elevator system 92a and the second elevator system 92b. As mentioned above, the floor coverage of the first elevator system 92a overlaps the floor coverage of the second elevator system 92b by at least one transfer floor, as seen in FIG. 2. In the example of FIG. 2, the transfer floor is floor 80d. At block 305, the system controller 110 detects if an evacuation call has been received from an evacuation floor. At block 305, if an evacuation call has been received from an evacuation floor then the method 300 will move to block 306. At block 305, if an evacuation call has not been received from an evacuation floor then the method 300 will move back to block 304. At block 306, the system controller 110 detects when a first elevator car 23a-23c of the first elevator system 92a is dispatched to the transfer floor. Once the first elevator car 23a-23c of the first elevator system 92a has been dispatched to the transfer floor, the control system 110 will determine the projected arrival time of the first elevator car 23a-23c at the transfer floor, at block 308. At block 310, a sensor system 76, detects the number of occupants within the first elevator car 23a-23c of the first elevator system 92a. At block 314, the system controller 110 determines how many elevator cars 23a-23c from the second elevator system 92b need to be sent to the transfer floor in response to the number of occupants detected within the first elevator car 23a-23c of the first elevator system 92a. At block 316, the system controller 110 dispatches at least one elevator car 23d-23f of the second elevator system 92b to the transfer floor. In an embodiment the elevator car 23d-23f of the second elevator system 92b is dispatched to arrive at the transfer floor within a selected time period of the projected arrival time of an elevator car 23a-23c of the first elevator system 92a. For instance, if the selected time period is zero then the elevator car 23d-23f of the second elevator system 92b is dispatched to arrive at the transfer floor at the same time the first elevator car 23a-23c of the first elevator system 92a is projected to arrive at the transfer floor. In an embodiment, the selected time period may be five seconds. In one embodiment, the selected time period may be greater than or less than five seconds.

At block 318, a notification device 74a-74f provides transfer instructions to the occupants of the first elevator car 23a-23c of the first elevator system 92a where on the transfer floor to board the second elevator car 23d-23f of the second elevator system 92b. At block 320, the control system 110 determines if there is a second transfer floor between the transfer floor and a discharge floor. A discharge floor may be a floor where occupants can evacuate the building 102. For example, in one embodiment the discharge floor may be a ground floor. In the example of FIG. 2, the discharge floor is 80a. At block 320, if there is a second transfer floor between the transfer floor and a discharge floor, the control system 110 will dispatch the elevator car 23 of the second elevator system 92b to the second transfer floor once occupants have transferred from the first elevator car 23a-23c of the first elevator system 92a at block 322 and then return to normal operation at block 304. At block 320 if there is not a second transfer floor between the transfer floor and a discharge floor, the control system 110 will dispatch the elevator car 23d-23f of the second elevator system 92b to the discharge floor once occupants have transferred from the first elevator car 23a-23c of the first elevator system 92a at block 324 and then return to block operation at block 304.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

1. A method of operating a building elevator system, the method comprising:
controlling a first elevator system and a second elevator system, floor coverage of the first elevator system overlapping floor coverage of the second elevator system at a position correspondence to at least one transfer floor;
receiving an evacuation call from an evacuation alarm on an evacuation floor;
generating an elevator call in response to the evacuation call from the evacuation alarm;
dispatching a first elevator car of the first elevator system to the evacuation floor;
detecting when the first elevator car of the first elevator system is dispatched from the evacuation floor to a transfer floor; and
dispatching a second elevator car of the second elevator system to the transfer floor.

2. The method of claim 1, further comprising:
dispatching the second elevator car to a discharge floor after occupants have loaded into the second elevator car on the transfer floor.

3. The method of claim 1, further comprising:
dispatching the second elevator car to a second transfer floor after occupants have loaded into the second elevator car on the transfer floor.

4. The method of claim 1, further comprising:
determining a projected arrival time of the first elevator car at the transfer floor;
wherein the second elevator car is dispatched to arrive at the transfer floor within a selected time period of the projected arrival time.

5. The method of claim 1, further comprising:
providing, using a notification device, transfer instructions to occupants.

6. The method of claim 1, further comprising:
detecting, using a sensor system, a number of occupants within the first elevator car.

7. The method of claim 6, further comprising:
determining a number of elevators cars from the second elevator system to be dispatched to the transfer floor in response to the number of occupants within the first elevator car.

8. A control system of a building elevator system comprising:
a processor;
a memory comprising computer-executable instructions that, when executed by the processor, cause the processor to perform operations, the operations comprising:
controlling a first elevator system and a second elevator system, floor coverage of the first elevator system overlapping floor coverage of the second elevator system at a position corresponding to at least one transfer floor;
receiving an evacuation call from an evacuation alarm on an evacuation floor;
generating an elevator call in response to the evacuation call from the evacuation alarm;
dispatching a first elevator car of the first elevator system to the evacuation floor;
detecting when the first elevator car of the first elevator system is dispatched from the evacuation floor to a transfer floor; and
dispatching a second elevator car of the second elevator system to the transfer floor.

9. The control system of claim 8, wherein the operations further comprise:
dispatching the second elevator car to a discharge floor after occupants have loaded into the second elevator car on the transfer floor.

10. The control system of claim 8, wherein the operations further comprise:
dispatching the second elevator car to a second transfer floor after occupants have loaded into the second elevator car on the transfer floor.

11. The control system of claim 8, wherein the operations further comprise:
determining a projected arrival time of the first elevator car at the transfer floor;
wherein the second elevator car is dispatched to arrive at the transfer floor within a selected time period of the projected arrival time.

12. The control system of claim 8, wherein the operations further comprise:
providing, using a notification device, transfer instructions to occupants.

13. The control system of claim 8, wherein the operations further comprise:
detecting, using a sensor system, a number of occupants within the first elevator car.

14. The control system of claim 13, wherein the operations further comprise:
determining a number of elevators cars from the second elevator system to be dispatched to the transfer floor in response to the number of occupants within the first elevator car.

15. A computer program product embodied on a computer readable medium, the computer program product including instructions that, when executed by a processor, cause the processor to perform operations comprising:
controlling a first elevator system and a second elevator system, floor coverage of the first elevator system overlapping floor coverage of the second elevator system at a position corresponding to at least one transfer floor;
receiving an evacuation call from an evacuation alarm an evacuation floor;
generating an elevator call in response to the evacuation call from the evacuation alarm;
dispatching a first elevator car of the first elevator system to the evacuation floor;
detecting when the first elevator car of the first elevator system is dispatched from the evacuation floor to a transfer floor; and
dispatching a second elevator car of the second elevator system to the transfer floor.

16. The computer program of claim 15, wherein the operations further comprise:
dispatching the second elevator car to a discharge floor after occupants have loaded into the second elevator car on the transfer floor.

17. The computer program of claim 15, wherein the operations further comprise:
dispatching the second elevator car to a second transfer floor after occupants have loaded into the second elevator car on the transfer floor.

18. The computer program of claim 15, wherein the operations further comprise:
determining a projected arrival time of the first elevator car at the transfer floor;
wherein the second elevator car is dispatched to arrive at the transfer floor within a selected time period of the projected arrival time.

19. The computer program of claim 15, wherein the operations further comprise:
providing, using a notification device, transfer instructions to occupants.

20. The computer program of claim 15, wherein the operations further comprise:
detecting, using a sensor system, a number of occupants within the first elevator car; and
determining a number of elevators cars from the second elevator system to be dispatched to the transfer floor in response to the number of occupants within the first elevator car.
